(19) United States
(12) Patent Application Publication
(10) Pub. No.: US 2013/0198774 A1
(43) Pub. Date: Aug. 1, 2013

(54) LIVE BROADCASTING OF DYNAMICALLY GENERATED CONTENT

(71) Applicant: CONSULTANTS NET CREATION INC., Quebec (CA)

(72) Inventors: Louis MASSICOTTE, Quebec (CA); Jean-Francois MONTPLAISIR, Quebec (CA)

(73) Assignee: CONSULTANTS NET CREATION INC., Quebec (CA)

(21) Appl. No.: 13/754,350

(22) Filed: Jan. 30, 2013

Related U.S. Application Data
(60) Provisional application No. 61/592,177, filed on Jan. 30, 2012.

(51) Int. Cl. H04N 21/435

(52) U.S. Cl. CPC H04N 21/435
USPC 725/32

(57) ABSTRACT

A method and system for integrating dynamically generated content to a live broadcast. The system enables a user to have information uniquely identifying him/her broadcast in real time when the user endorses a given item through the social network. In particular, a user of a social network may have his/her profile information broadcast.

### CROSS-REFERENCE TO RELATED APPLICATIONS

This application claims priority under 35 U.S.C. §119(e) from U.S. Provisional Patent Application No. 61/592,177, filed on Jan. 30, 2012, the contents of which are hereby incorporated by reference.

### TECHNICAL FIELD

The present invention relates to the field of social broadcasting. In particular, social networking content is integrated to a live television broadcast.

### BACKGROUND OF THE ART

Over time, the experience of traditional forms of media, such as television, has been made more enjoyable by recent advances in television technologies. In order to increase user participation, efforts have been made to incorporate social media into the television platform. Social networking sites such as Facebook™ or Twitter™ have indeed brought about a new form of social media based on live broadcasting of unfiltered content to the general public. As such, new forms of interactive communication can be achieved.

An example of this is the live Twitter feeds, which are broadcast on networks such as CNN™. These feeds are continuously scrolled at the bottom of a television screen in real time. However, such a setup does not provide any particular filter with regards to the content being broadcast in the feed. In addition, the source of the feed is typically limited to a set of predetermined user accounts. As such, content Tweeted impulsively by an individual from the general public will not be broadcast live on the network if this individual is not one of the predetermined users. Moreover, as altering conventional infrastructures for delivering television signals proves costly, the interactivity between viewers and television programming remains limited.

There is therefore a need to further develop the integration of various forms of social media with more traditional-type television broadcasting.

### SUMMARY

There is described herein a method and system for integrating dynamically generated content to a live broadcast. The system enables a user of to have his or her profile information broadcast in real time when the user endorses a given merchant item.

In accordance with a first broad aspect, there is provided a system for integrating dynamically generated content to a live broadcast rendered on an end terminal. The system comprises a server communicable with at least one user interface over a network and in communication with the end terminal, the server having a memory and a processor. The system further comprises at least one application stored in the memory and executable by the processor for receiving from the at least one user interface input data representative of at least one endorsement of at least one item, obtaining user information uniquely identifying at least one user of the at least one user interface, associating the user information with the at least one endorsed item to form at least one endorsement feed, and dynamically integrating the at least one endorsement feed to the live broadcast for rendering on the end terminal.

Still in accordance with another broad aspect, there is also provided a computer-implemented method for integrating dynamically generated content to a live broadcast rendered on an end terminal. The method comprises executing on a processor program code for receiving from at least one user interface input data representative of at least one endorsement of at least one item, obtaining user information uniquely identifying at least one user of the at least one user interface, associating the user information with the at least one endorsed item to form at least one endorsement feed, and dynamically integrating the at least one endorsement feed to the live broadcast for rendering on the end terminal.

Still in accordance with another broad aspect, there is also provided a computer readable medium having stored thereon program code executable by a processor for integrating dynamically generated content to a live broadcast rendered on an end terminal. The program code is executable for receiving from at least one user interface input data representative of at least one endorsement of at least one item, obtaining user information uniquely identifying at least one user of the at least one user interface, associating the user information with the at least one endorsed item to form at least one endorsement feed, and dynamically integrating the at least one endorsement feed to the live broadcast for rendering on the end terminal.

### BRIEF DESCRIPTION OF THE DRAWINGS

Further features and advantages of the present invention will become apparent from the following detailed description, taken in combination with the appended drawings, in which:

FIG. 1 is a schematic diagram of a system for live broadcasting of dynamically generated content in accordance with an illustrative embodiment of the present invention;

FIG. 2a is a schematic diagram of a broadcasting server in accordance with an illustrative embodiment of the present invention;

FIG. 2b is a schematic diagram of an application running on the processor of FIG. 1;

FIG. 3 is a flowchart of a method of integrating social networking content with a live broadcast in accordance with an illustrative embodiment of the present invention;

FIG. 4 is a schematic diagram of a user interface utilized in the method of FIG. 3 in accordance with an illustrative embodiment of the present invention; and

FIG. 5 is a schematic diagram of a broadcast station utilized in the method of FIG. 3 in accordance with an illustrative embodiment of the present invention.

It will be noted that throughout the appended drawings, like features are identified by like reference numerals.

### DETAILED DESCRIPTION

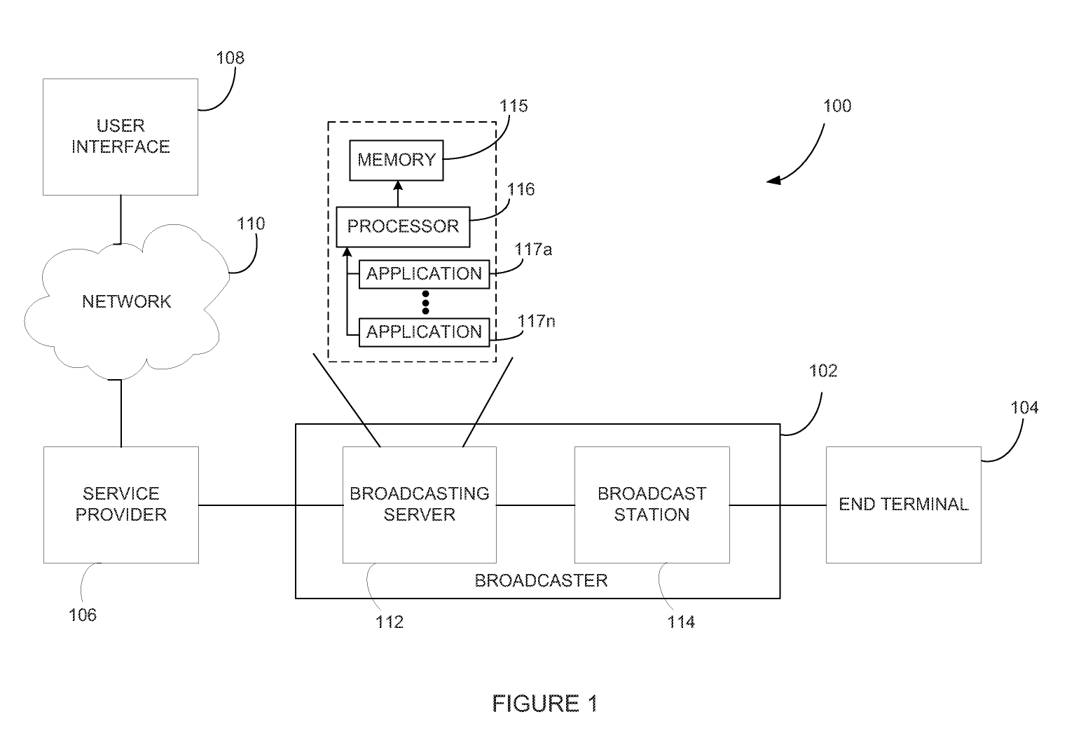

Referring to FIG. 1, there is described a system 100 for live broadcasting of social media. The system 100 comprises a broadcaster 102 that broadcasts television signals to an end terminal 104 owned by a customer. The end terminal 104 illustratively comprises any terminal capable of receiving and processing the broadcast signals for presentation to the user, for example televisions, personal computers, or smartphones. The broadcast signals are transmitted from the broadcaster 102 to the end terminal 104 by any suitable means, such as by way of coaxial cable, satellite connection, or over the air using an antenna (not shown). The live broadcast may therefore be at least a terrestrial television broadcast, a satellite television broadcast, a cable television broadcast, or a digital television broadcast.

The system 100 further comprises a service provider 106 in communication with the broadcaster 102 and with a user interface 108 over a network 110, such as the Internet, the Public Switch Telephone Network (PSTN), a cellular network, or others known to those skilled in the art. The user interface 108 may or may not be associated to the end terminal 104 on which the broadcast is displayed and illustratively comprises any device through which the user may log in to an online social network or social networking application (e.g. Facebook, Google+™, Twitter or the like), which may or may not require a user subscription. Once logged in to the social network, the user may navigate through the page of a given merchant company associated with the social network. The user is then able to provide input through the user interface 108, which directly influences the content of the live broadcast feed. For this purpose, the broadcaster 102 illustratively comprises a broadcasting server 112 connected to a broadcast station 114. The broadcasting server 112 may be a single machine or span a plurality of machines used to provide services that coordinate the user's influence on the current broadcast. The broadcast station 114 is connected to the broadcasting server 112 through any public or private network and outputs to the end terminal 104 content, which is ready for broadcast. The broadcast station 114 may illustratively comprise any broadcast infrastructure, such as satellite, computer network, or radio frequency.

The broadcasting server 112 comprises, amongst other things, a memory 115 having coupled thereto a processor 116 on which are running a plurality of applications 117a . . . 117n. It should be understood that while the applications 117a . . . 117n presented herein are illustrated and described as separate entities, they may be combined or separated in a variety of ways. The processor 116 is illustratively represented as a single processor but may correspond to a multi-core processor or a plurality of processors operating in parallel.

The memory 115 accessible by the processor 116 receives and stores data. The memory 115 may be a main memory, such as a high speed Random Access Memory (RAM), or an auxiliary storage unit, such as a hard disk or flash memory. The memory 115 may be any other type of memory, such as a Read-Only Memory (ROM), Erasable Programmable Read-Only Memory (EPROM), or optical storage media such as a videodisc and a compact disc.

The processor 116 may access the memory 115 to retrieve data. The processor 116 may be any device that can perform operations on data. Examples are a central processing unit (CPU), a front-end processor, a microprocessor, a graphics processing unit (GPU/VPU), a physics processing unit (PPU), a digital signal processor, and a network processor. The applications 117a . . . 117n are coupled to the processor 116 and configured to perform various tasks as explained below in more detail.

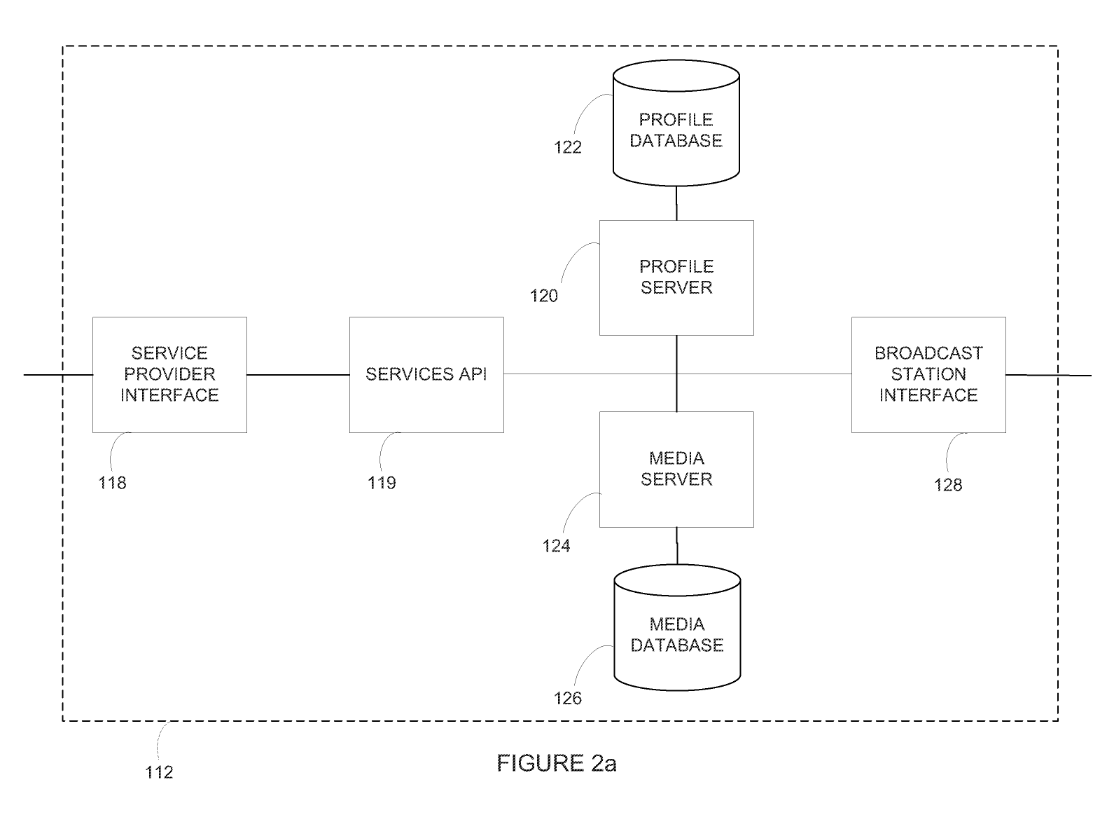

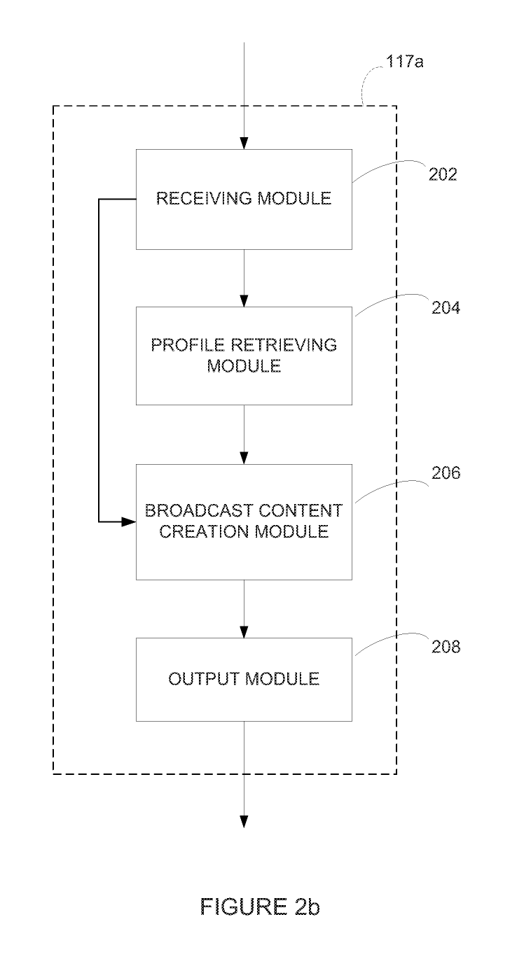

Referring now to FIG. 2a in addition to FIG. 1, upon receipt of endorsement input from the user, the broadcasting server 112 retrieves the user's social network profile information for integration with the live broadcast. The system 100 is illustratively automated such that no human intervention is needed to create the dynamically generated content of the live feed. Software running on the broadcasting server 112 receives from the service provider 106 data from which the live feed is created. For this purpose, the broadcasting server 112 illustratively comprises a service provider interface 118 used to interface with the service provider 106 and to process information received therefrom. A services Application Programming Interface (API) 119 is further provided to enable interfacing with websites, portals, web applications, mobile technologies and the like.

Still referring to FIG. 2a, after receiving the user's endorsement, a profile server 120 retrieves the user's profile information through the services API 119. This information is then stored in a profile database 122 for subsequent use and transmitted to the media server 124 for creating the content to be broadcast. The media server 124 is indeed used to format media content provided from the service provider 106 for live broadcast. As such, the media server 124 provides signal processing and filtering of content and media (e.g. volume or brightness normalization for audio/video media) and further integrates the retrieved profile information to the broadcast. A media database 126 is used to facilitate storage of the generated media content. Once the media is ready for broadcast, a broadcast station interface 128 is used to interface the broadcast content to the broadcast station 114 for transmission of the live feed to the end terminal 104.

The profile server 120 and media server 124 described herein illustratively each comprise a processor (not shown), which may be any device that can perform operations on data. Examples are a central processing unit (CPU), a front-end processor, a microprocessor, a graphics processing unit (GPU/VPU), a physics processing unit (PPU), a digital signal processor, and a network processor. Although the profile server 120 and the media server 124 have been described and illustrated as separate entities, it should be understood that they may be integrated as a single server.

The profile database 122 and media database 126 may be integrated directly into the memory (reference 115 in FIG. 1) or separated therefrom and remotely from the broadcasting server 112. In the case of a remote access to the databases, access may occur via any type of network 110. The profile database 122 and media database 126 described herein may be provided as collections of data or information organized for rapid search and retrieval by a computer. They are structured to facilitate storage, retrieval, modification, and deletion of data in conjunction with various data-processing operations. They may consist of a file or sets of files that can be broken down into records, each of which consists of one or more fields. Database information may be retrieved through queries using keywords and sorting commands, in order to rapidly search, rearrange, group, and select the field. The databases 122 and 126 may be any organization of data on a data storage medium, such as one or more servers. Although illustrated as being separate, it should be understood that the databases 122 and 126 may be integrated as a single database.

In one embodiment, the databases 122 and 126 are secure web servers and Hypertext Transport Protocol Secure (HTTPS) capable of supporting Transport Layer Security (TLS), which is a protocol used for access to the data. Communications to and from the secure web servers may be secured using Secure Sockets Layer (SSL). An SSL session may be started by sending a request to the Web server with an HTTPS prefix in the URL, which causes port number “443” to be placed into the packets. Port “443” is the number assigned to the SSL application on the server. Identity verification of a user may be performed using usernames and passwords for all users. Various levels of access rights may be provided to multiple levels of users.

Illustratively, any known communication protocols that enable devices within a computer network to exchange information may be used to enable communication between the various components of the system 100. Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol), POP3 (Post Office Protocol 3), SMTP (Simple Mail Transfer Protocol), IMAP (Internet Message Access Protocol), SOAP (Simple Object Access Protocol), PPP (Point-to-Point Protocol), RFB (Remote Frame buffer) Protocol.

FIG. 2b illustrates an exemplary application 117a running on the processor 116 of FIG. 1. The application 117a comprises at least a receiving module 202, a profile retrieving module 204, a broadcast content creation module 206, and an output module 208. It should be understood that the profile retrieving module 204 may be provided in an application running on the processor of the profile server (reference 120 of FIG. 2a) while the broadcast content creation module 206 may be provided in an application running on the processor of the media server (reference 124 of FIG. 2a).

The receiving module 202 illustratively receives from the service provider 106 media content, e.g. content corresponding to a live ongoing event, for broadcast. The media content may then be sent to the broadcast content creation module 206. The receiving module 202 may further receive input data comprising user data uniquely identifying the user and endorsement data indicative of the user's endorsement of a given item. The user data may comprise a username and password associated with the user's social network profile. The user data may then be transmitted to the profile retrieving module 204 so the latter may retrieve from the memory 115 and/or database 122 the social network profile information corresponding to the received username and password. Indeed, in one embodiment, the memory 115 and/or database 122 may have stored therein a plurality of records comprising profile information associated with a plurality of users of the social networking service.

In one embodiment, the profile retrieving module 204 may apply one or more rules to ensure that only the user's name and photo are retrieved from the profile information. In addition, the profile retrieving module 204 may use computational linguistics, moderation rules, or other constraints to filter the profile elements, e.g. name and photo, retrieved from the user's profile information. In this manner, undesirable, e.g. vulgar, violent, hateful, or otherwise inappropriate, content may be automatically excluded. If it is found that at least one of the selected profile elements fails to match one or more rules, the profile retrieving module 204 can conclude that the profile elements are inappropriate for broadcast and the elements are rejected. Otherwise, the profile retrieving module 204 transmits the retrieved profile element(s) along with identification of the endorsed item to the broadcast content creation module 206.

As discussed further below, a user having not subscribed to a social network may endorse an item. In this case, the user may be prompted to enter information, e.g. a name, to be included in the live broadcast. The user-provided information may be received at the receiving module 202 along with the endorsement data. The receiving module 202 may then transmit this information to the broadcast content creation module 206 directly, without communicating with the profile retrieving module 204.

Upon receiving the user provided information from the receiving module 202 or the retrieved profile elements from the profile retrieving module 204, the broadcast content creation module 206 may associate the received user information to the endorsed item to create a live endorsement feed. In particular, the created feed may, upon being displayed, cause the retrieved profile elements to be broadcast in relation to the endorsed item. For instance, the displayed endorsement feed may indicate that the user, which is identified by his/her name and/or photo, has endorsed the item in question. As will be discussed further below, more than one item may be endorsed and more than one live endorsement feed may therefore be created. For instance, users may indicate interest for one of several available items and one endorsement feed may be created by the broadcast content creation module 206 for each endorsed item.

The broadcast content creation module 206 may then dynamically combine the created endorsement feed to the media content received from the receiving module 202. The broadcast content creation module 206 may further perform signal processing and filtering of the combined information to ensure volume normalization, brightness normalization, or the like. A signal including the combined information may then be generated by the broadcast content creation module 206 and transmitted to the output module 208.

The output module 208 may in turn format the received data into a format suitable for transmission to the broadcast station 114 and rendering on the end terminal 104. In particular, upon receiving the combined information, the end terminal 104 is illustratively caused to display on a first portion of a screen thereof the media content corresponding to the ongoing live program and on a second portion of the screen the endorsement feed. In one embodiment, the combined information may be formatted so that the media content is displayed on substantially the full screen while the endorsement feed is displayed as at least one overlay or banner. The overlay may obstruct the view of a portion of the media content. The amount of overlay may be restricted to no more than 20% of the full screen area. Alternatively, the endorsement feed may be displayed in a portion of the screen that is non-overlapping with the remaining portion of the screen on which the media content is being displayed.

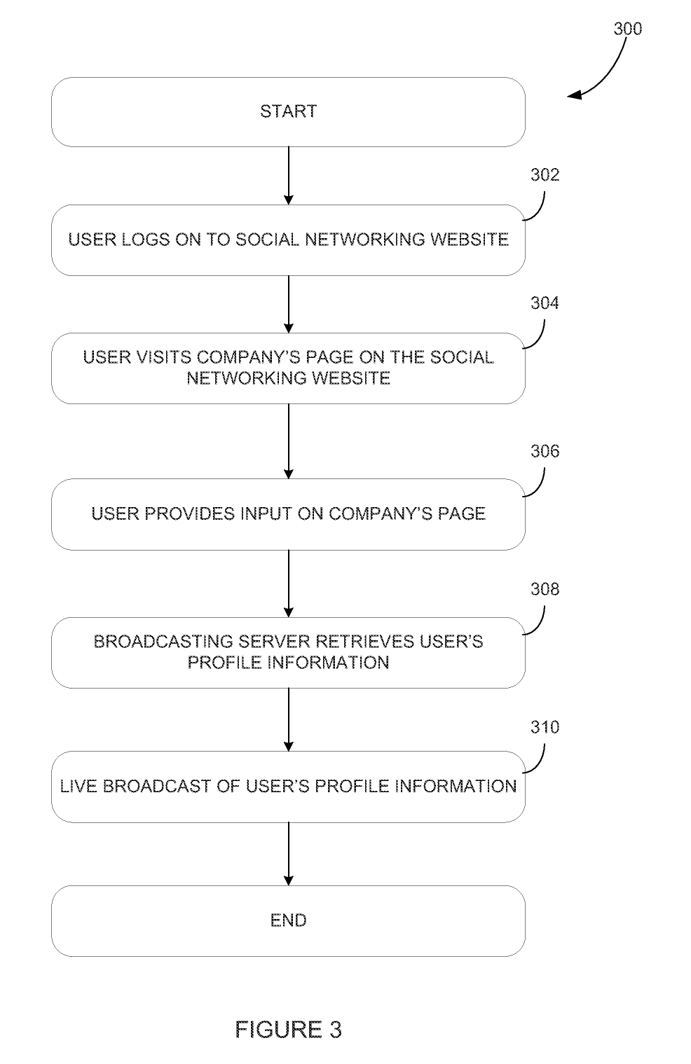

Referring now to FIG. 3, a method 300 for integrating social networking content with a live broadcast will now be described. Illustratively, a user having subscribed to an online social network logs on thereto through a website or application (step 302) and may subsequently visit (step 304) the website of a given company of interest, which participates in the social network by having a social networking page. Upon navigating the company's website, if the user wishes to indicate his or her interest in the company or endorse one of the company's products, the user may associate the latter with a feedback icon, not shown (step 306). Examples of such feedback icons include but are not limited to the “Like” feature of Facebook, the “+1” feature of Google+, and the “Follow” feature of Twitter.

In an alternative embodiment, a subscribed user may be prompted to log into the social network after associating the product with the feedback icon and as such, the order of steps 302 to 306 would be altered. Also, subscription to an online social network is not be mandatory as an unsubscribed user may still visit the company's website and be prompted to enter personal information for display during the live broadcast subsequent to associating the product with the feedback icon.

Still referring to FIG. 3, the broadcast server 112 illustratively retrieves selective profile information about the user (step 308). A user profile is typically generated as a user subscribes to the social network and may include a plurality of customized subscription information and personal settings including a username, photo, age, gender, marital status, interests, video and/or pictographic content accumulated by the user. Illustratively, only the name and photo of the user are retrieved from the profile and associated with the item indicated as of interest in order to form a feed that will be integrated to the live broadcast for display on the end terminal 104 (step 310). In this manner, new endorsers of the company or product are displayed in real time during the broadcast. In one embodiment, in the event that, over a certain period of time, no new user has shown interest for the company through the use of the feedback icon, previous endorsers keep being broadcast in an automated queue until new endorsers are identified.

As only the user's name and no other text information found on the user's profile is displayed, broadcasting of vulgar language is avoided. This can be further avoided by using computational linguistics to automatically exclude undesirable language from being made public, as discussed above. Additional security features may also be implemented to further prevent personal information other than the user's name and photo from being broadcast.

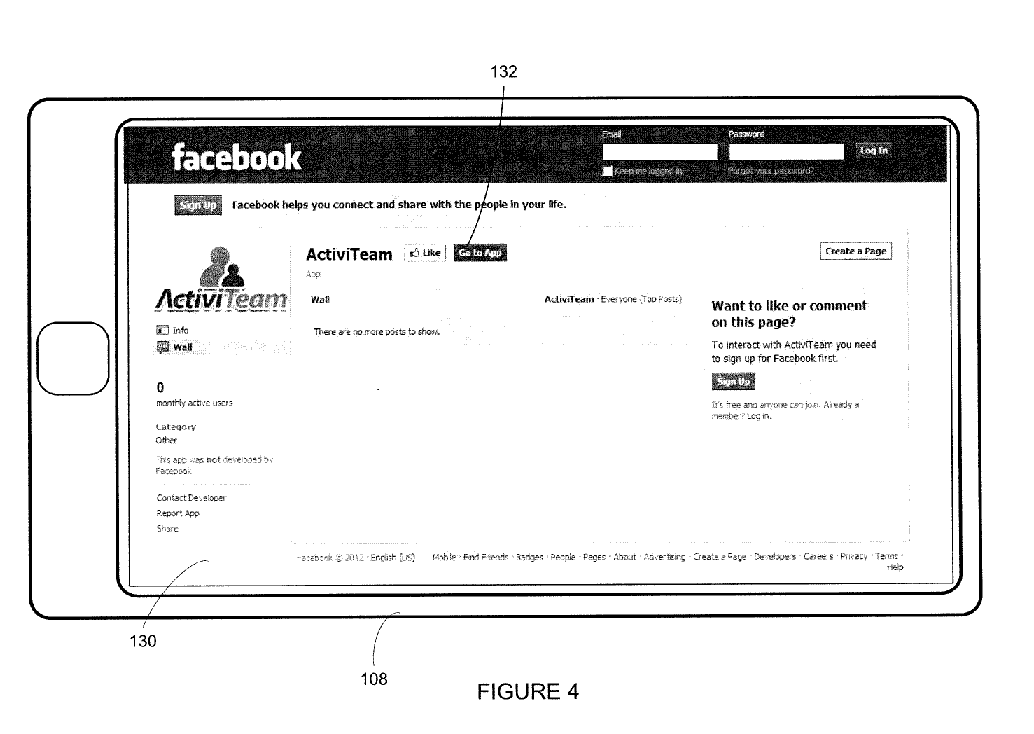

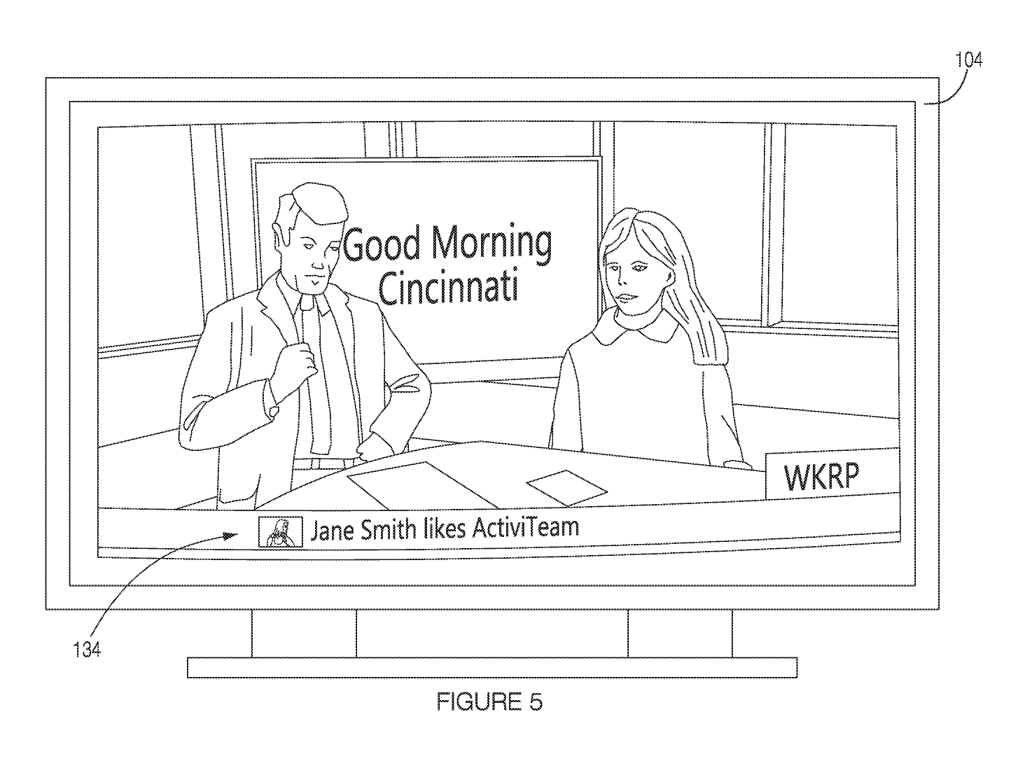

Referring now to FIG. 4 and FIG. 5, a user, say Jane Smith, may use the user interface 108 to navigate on the Facebook page 130 of sports company ActiviTeam™. User interface 108 is illustratively a smart phone having advanced connectivity. The user wishing to show interest for ActiviTeam then clicks on the “Like” feedback icon 132. As a result, Jane Smith's name and picture are scrolled during a live television show across the end terminal 104, illustratively a television screen, as a banner 134 showing Jane Smith's endorsement of ActiviTeam.

In one embodiment, a user may endorse more than one item and the banner 134 may accordingly comprise a plurality of sections (not shown) each associated with a corresponding endorsed item. For instance, users may be prompted to indicate interest for one of two (2) items, such as two (2) teams competing in a sports event. The banner 134 may then comprise a first area (not shown) displaying information associated with users having endorsed the first item, e.g. the first team, and a second area (not shown) displaying information associated with users having endorsed the second item, e.g. the first second. In this manner, it becomes possible to track user interest for each item independently.

Still referring to FIG. 4 and FIG. 5 and according to an alternative illustrative embodiment of the present invention, the user may also access the webpage of any live television show to cast votes throughout an episode of the show. In this embodiment, users are prompted to indicate their favorite contestant from a list of contestants participating in the show and displayed on the webpage. As soon as a user votes for a given candidate, the voting result together with the voter's personal information (e.g. name and picture) are broadcast in real time across the end terminal 104.

Illustratively, the system 100 may also be used to broadcast personal information about a user having purchased an item on an online shopping site, such as eBay™, or on an online digital media store, such as iTunes™. The system may also enable information related to a user having newly subscribed to an online newspaper, magazine, or the like to be broadcast live across the end terminal 104. In this case and as discussed herein above, the broadcast information may be retrieved from the user's social networking profile or alternatively the user may be prompted to enter the information he or she wishes to have presented during the live broadcast. In the latter case, the entered information may then be stored in the profile database 122 for subsequent retrieval and integration in the live broadcast.

Referring back to FIG. 1, the system 100 advantageously provides incentives for users to give positive feedback and endorse products of participating companies by having the user's information displayed live on the end terminal 104. As a result, interactive participation of multiple users in the creation of the live feed being broadcast is achieved and support of participating merchants is stimulated. This form of advertising proves particularly useful for merchants and other companies or entities wishing to increase the visibility of their brand by generating a fan base for their social networking pages and showcasing their social media leadership. Moreover, such a format becomes a money generating platform for a given television network, such as NBC™, ABC™, CNN™, and the like. Indeed, the Network illustratively sells blocks of time, e.g. 15 minutes, per show to a given merchant, who in turn links his products or social networking page to the live broadcasting feature.

While illustrated in the block diagrams as groups of discrete components communicating with each other via distinct data signal connections, it will be understood by those skilled in the art that the present embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment.

It should be noted that the present invention can be carried out as a method, can be embodied in a system, a computer readable medium or an electrical or electro-magnetic signal. The embodiments of the invention described above are intended to be exemplary only. The scope of the invention is therefore intended to be limited solely by the scope of the appended claims.

1. A system for integrating dynamically generated content to a live broadcast rendered on an end terminal, the system comprising:
a server communicable with at least one user interface over a network and in communication with the end terminal, the server having a memory and a processor; and
at least one application stored in the memory and executable by the processor for receiving from the at least one user interface input data representative of at least one endorsement of at least one item, obtaining user information uniquely identifying at least one user of the at least one user interface, associating the user information with the at least one endorsed item to form at least one endorsement feed, and dynamically integrating the at least one endorsement feed to the live broadcast for rendering on the end terminal.

2. The system of claim 1, wherein the memory has stored therein profile information of each one of a plurality of users of a social network and further wherein the at least one application is executable by the processor for selectively retrieving from the memory the profile information of the at least one user to obtain the user information.

3. The system of claim 2, wherein the at least one application is executable by the processor for retrieving at least one of a username and a photo from the profile information of the at least one user and for associating the at least one of the username and photo with the at least one endorsed item to form the at least one endorsement feed.

4. The system of claim 2, wherein the at least one application is executable by the processor for applying at least one rule to the profile information to prevent undesirable content from being retrieved from the profile information.

5. The system of claim 1, wherein the at least one application is executable by the processor for receiving the user information from the at least one user interface.

6. The system of claim 1, wherein the at least one application is executable by the processor for receiving from the at least one user interface the input data further to the at least one user associating the at least one item with a feedback icon provided on a social networking service, accessing a webpage of a live television show to cast a vote for the at least one item throughout the live broadcast of the show, or purchasing the at least one item through an online retail site.

7. The system of claim 1, wherein the at least one application is executable by the processor for causing the live broadcast to be rendered in a first portion of a screen of the end terminal and the at least one endorsement feed to be rendered in a second portion of the screen.

8. The system of claim 7, wherein the at least one application is executable by the processor for causing the at least one endorsement feed to be rendered in the second portion of the screen with the second portion being one of overlaid on and non-overlapping with the first portion.

9. The system of claim 7, wherein the at least one application is executable by the processor for
receiving from a first user interface first input data representative of a first endorsement of a first item and from a second user interface second input data representative of a second endorsement of a second item,
obtaining first user information uniquely identifying a first user of the first user interface and second user information uniquely identifying a second user of the second user interface,
associating the first user information with the first endorsed item to form a first endorsement feed and the second user information with the second item to form a second endorsement feed, and
causing the first and second endorsement feeds to be respectively rendered in a first and a second area of the second portion of the screen.

10. The system of claim 1, wherein the live broadcast comprises at least one of a terrestrial television broadcast, a satellite television broadcast, a cable television broadcast, and a digital television broadcast.

11. A computer-implemented method for integrating dynamically generated content to a live broadcast rendered on an end terminal, the method comprising executing on a processor program code for:
receiving from at least one user interface input data representative of at least one endorsement of at least one item;
obtaining user information uniquely identifying at least one user of the at least one user interface;
associating the user information with the at least one endorsed item to form at least one endorsement feed; and
dynamically integrating the at least one endorsement feed to the live broadcast for rendering on the end terminal.

12. The method of claim 11, wherein obtaining the user information comprises selectively retrieving from a memory having stored therein profile information of each one of a plurality of users of a social network the profile information of the at least one user.

13. The method of claim 12, wherein obtaining the user information comprises retrieving at least one of a username and a photo from the profile information of the at least one user and further wherein associating the user information with the at least one endorsed item comprises associating the at least one of the username and photo with the at least one endorsed item.

14. The method of claim 12, further comprising applying at least one rule to the profile information to prevent undesirable content from being retrieved from the profile information.

15. The method of claim 11, wherein obtaining the user information comprises receiving the user information from the at least one user interface.

16. The method of claim 11, wherein receiving the input data comprises receiving the input data further to the at least one user, via the at least one user interface, associating the at least one item with a feedback icon provided on a social networking service, accessing a webpage of a live television show to cast a vote for the at least one item throughout the live broadcast of the show, or purchasing the at least one item through an online retail site.

17. The method of claim 11, wherein dynamically integrating the endorsement feed to the live broadcast comprises causing the live broadcast to be rendered in a first portion of a screen of the end terminal and the at least one endorsement feed to be rendered in a second portion of the screen.

18. The method of claim 17, wherein dynamically integrating the endorsement feed to the live broadcast comprises causing the at least one endorsement feed to be rendered in the second portion of the screen with the second portion being one of overlaid on and non-overlapping with the first portion.

19. The method of claim 17, wherein
receiving the input data comprises receiving from a first user interface first input data representative of a first endorsement of a first item and from a second user interface second input data representative of a second endorsement of a second item,
obtaining the user information comprises obtaining first user information uniquely identifying a first user of the first user interface and second user information uniquely identifying a second user of the second user interface,
associating the user information with the at least one endorsed item comprises associating the first user information with the first endorsed item to form a first endorsement feed and the second user information with the second item to form a second endorsement feed, and
dynamically integrating the at least one endorsement feed to the live broadcast comprises causing the first and second endorsement feeds to be respectively rendered in a first and a second area of the second portion of the screen.

20. A computer readable medium having stored thereon program code executable by a processor for integrating dynamically generated content to a live broadcast rendered on an end terminal, the program code executable for:
receiving from at least one user interface input data representative of at least one endorsement of at least one item;
obtaining user information uniquely identifying at least one user of the at least one user interface;
associating the user information with the at least one endorsed item to form at least one an endorsement feed; and
dynamically integrating the at least one endorsement feed to the live broadcast for rendering on the end terminal.
